(19) United States
(12) Patent Application Publication
(10) Pub. No.: US 2025/0043430 A1
(43) Pub. Date: Feb. 6, 2025

(54) LASER ASSISTED COLD SPRAY REPAIR DEVICE AND PROCESS METHOD FOR AVIATION-GRADE ALUMINUM ALLOY STRUCTURAL PARTS

(71) Applicant: Air Force Engineering University, Xi'an (CN)

(72) Inventors: LIUCHENG ZHOU, Xi’an (CN); ZONGHUI CHENG, Wuhu (CN); QIANG WANG, Xi’an (CN); XINLEI PAN, Xi’an (CN); SONG SHU, Wuhu (CN); WENJUAN NIU, Xi’an (CN); XIAOQING LIANG, Xi’an (CN); WEIFENG HE, Xi’an (CN)

(21) Appl. No.: 18/229,871

(22) Filed: Aug. 3, 2023

(51) Int. Cl. C23C 24/04

(52) U.S. Cl. CPC C23C 24/04; B05B 7/164; B05B 7/228

(57) ABSTRACT

Disclosed are a laser assisted cold spray repair device and process method for aviation-grade aluminum alloy structural parts. In the present disclosure, a laser device, a high-pressure gas source, a powder feeder, a water cooling system, a reflector, an integrated spray gun, a mobile platform, an air pipe, a powder-gas mixed channel, a lower-pressure powder-gas powder feeding port, an air pressure regulating valve, a high-pressure airflow heater and a powder pipe are included. The powder spray gun and a heating laser source are connected coaxially, and a processing zone of the mobile platform is provided with a specimen to be processed. In the present disclosure, fatigue properties of repaired aviation-grade aluminum alloy specimens are restored to an original state before damage and satisfy service requirements.

### TECHNICAL FIELD

The present disclosure belongs to the technical field of cold spray technology, and particularly relates to a laser assisted cold spray repair device and process method for aviation-grade aluminum alloy structural parts.

### BACKGROUND

At present, damages of aviation-grade aluminum alloy structural parts are repaired mainly by using cold spray technology. However, in the process of cold spray repair, it mainly depends on kinetic energy of particles to form a deposition layer. The bonding mode between different particles is mechanical bonding, which cannot form metallurgical bonding, resulting in insufficient binding strength. In addition, after cold spray repair, residual stress fields around a repaired zone are not uniform, which leads to a risk of stress concentration. In this case, the fatigue properties of the repaired parts cannot be restored to an original state before the damage. Therefore, the traditional cold spray technology is not suitable for the repair of aluminum alloy bearing parts, which greatly limits the application of the cold spray technology. Therefore, we propose a laser assisted cold spray repair device and process method for aviation-grade aluminum alloy structural parts to achieve high performance repair.

### SUMMARY

An objective of the present disclosure is as follows: the present application provides a laser assisted cold spray repair device and process method for aviation-grade aluminum alloy structural parts so as to make fatigue properties of repaired aviation-grade aluminum alloy bearing parts be restored to an original state before damage and satisfy service requirements.

The technical solutions employed by the present disclosure are as follows:

A laser assisted cold spray repair device for aviation-grade aluminum alloy structural parts includes a laser device, a high-pressure gas source, a powder feeder, a water cooling system, a reflector, an integrated spray gun and a mobile platform, where an output end of the laser device emits a laser beam, the laser beam enters an interior of the integrated spray gun after being refracted by the reflector, an inner cavity of the high-pressure gas source is in communication with an air pipe, and the end, far away from the high-pressure gas source, of the air pipe is in communication with a powder-gas mixed channel and a low-pressure powder-gas powder feeding port. An air pressure regulating valve is arranged on an outer surface of the end, close to the high-pressure air source, of the air pipe, and a high-pressure airflow heater is arranged on an outer surface of the portion, at a right end of the air pressure regulating valve, of the air pipe. An inner cavity of the powder feeder is in communication with a powder pipe, and the end, far away from the powder feeder, of the powder pipe is in communication with inner cavities of the powder-gas mixed channel and the low-pressure powder-gas powder feeding port. An inner cavity of the water cooling system is in communication with a water pipe, and the end, far away from the water cooling system, of the water pipe is in communication with the integrated spray gun. The inner cavity of the low-pressure powder-gas powder feeding port is in communication with the integrated spray gun, and inner cavity of the powder-gas mixed channel is in communication with a Laval nozzle. A processing zone of the mobile platform is provided with a specimen to be processed, and the specimen is positioned right below the integrated spray gun.

In a preferred invention manner, a deionized water nozzle is arranged above a right side of the specimen.

In a preferred invention manner, the laser device is electrically connected to an input end of the water cooling system.

In a preferred invention manner, the integrated spray gun includes a conical housing, a laser beam channel is arranged inside the conical housing, and an inner partition plate is arranged between the conical housing and the laser beam channel.

In a preferred invention manner, an angle between a central axis of the powder-gas mixed channel and a central axis of the laser beam channel is 15°-60°.

In a preferred invention manner, a water cooling channel is located between an inner surface of the conical housing and an outer surface of the inner partition plate.

In a preferred invention manner, the central axis of the laser beam channel, the central axis of the powder-gas mixed channel and a central axis of the conical housing are collinear.

In a preferred invention manner, the conical housing has a conical angle of 15°-60° and a minimum diameter of a front end of 30 to 100 mm, and a minimum diameter of the laser beam channel is 1 to 3 mm.

In summary, due to employing the above technical solutions, the present disclosure has the beneficial effects as follows:

In the present disclosure, for the laser assisted cold spray high performance repair method and device, cold spray particles and deposition positions are heated in situ by using low-power density laser to induce the deposition particles to form metallurgical bonding, so as to improve the bonding strength of coating. After the cold spray repair, high-power density laser is employed to peen the repaired zone, control the residual stress field distribution around the repaired zone and optimize microstructure so as to improve the fatigue properties. The fatigue properties of the repaired aviation-grade aluminum alloy specimens are restored to an original state before damage and satisfy service requirements.

### BRIEF DESCRIPTION OF DRAWINGS

FIG. 1 is a diagram of a laser assisted cold spray device of the present disclosure;

FIG. 2 is a structural diagram of a laser assisted cold spray gun of the present disclosure;

FIG. 3 is a laser assisted cold spray repair process for aviation-grade aluminum alloy structural parts in the present disclosure;

FIG. 4 is a schematic diagram of laser assisted cold spray repair of an aluminum alloy specimen with a pre-crack in the present disclosure;

FIG. 5 is a schematic diagram of laser shock peening process after laser assisted cold spray repair in the present disclosure;

FIG. 6 is a view of an aluminum alloy fatigue specimen with a pre-crack in the present disclosure;

FIG. 7 is a view of a laser assisted cold spray repair specimen in the present disclosure;

FIG. 8 is a TEM image of a deposition in the present disclosure;

FIG. 9 is a graph showing residual stress distribution around a repaired zone in the present disclosure;

FIG. 10 is a graph showing test results of bonding strength of repaired specimen by laser assisted cold spray in the present disclosure;

FIG. 11 is a graph showing test results of fatigue strength of repaired specimen by laser assisted cold spray in the present disclosure.

In the figures: 1—laser device; 2—laser beam; 3—powder regulating valve; 4—powder pipe; 5—high-pressure gas source; 6—powder feeder; 7—water cooling system; 8—air pressure regulating valve; 9—powder airflow heater; 10—high-pressure airflow heater; 11—reflector; 12—powder-gas mixed channel; 13—integrated spray gun; 14—deionized water nozzle; 15—lower-pressure powder-gas powder feeding port; 16—mobile platform; 17—specimen to be processed; 18—inner partition plate; 19—Laval nozzle; 20—water cooling channel; 21—conical housing; 22—laser beam channel; 23—cold spray particle; 24—deposition; 25—peening zone; and 26—laser spot.

### DETAILED DESCRIPTION

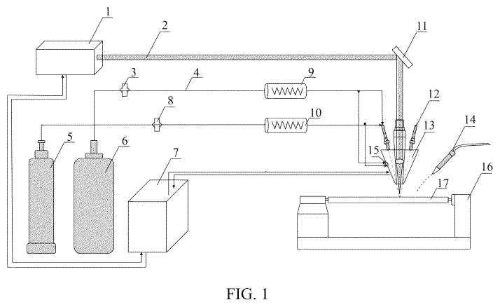

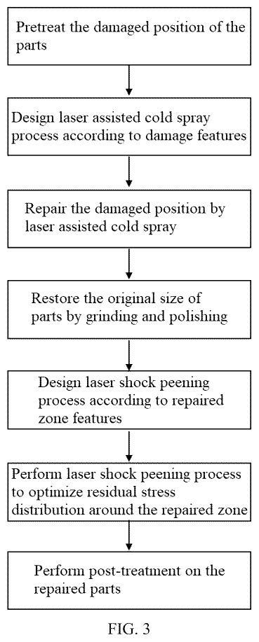

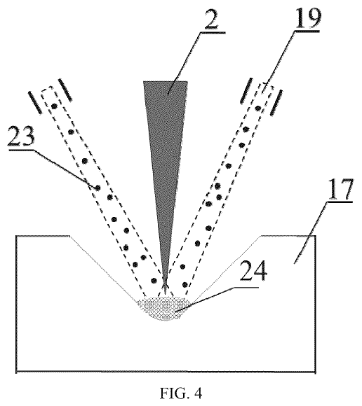

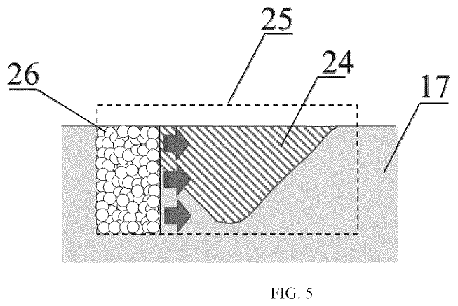

A laser assisted cold spray repair device and process method for aviation-grade aluminum alloy structural parts in an example of the present disclosure will be described in detail with reference to FIGS. 1-11.

### Example

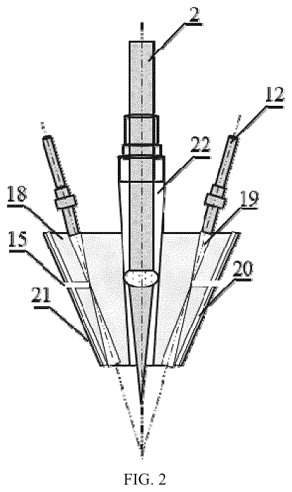

With reference to FIG. 1 and FIG. 2, a laser assisted cold spray repair device and process method for aviation-grade aluminum alloy structural parts are provided. The device includes a laser device 1, a high-pressure gas source 5, a powder feeder 6, a water cooling system 7, a reflector 11, an integrated spray gun 13, and a mobile platform 16. An output end of the laser device 1 emits a laser beam 2, and the laser beam 2 enters an interior of the integrated spray gun 13 after being refracted by the reflector 11. An inner cavity of the high-pressure gas source 5 is in communication with an air pipe, the end, far away from the high-pressure gas source 5, of the air pipe is in communication with a powder-gas mixed channel 12 and a low-pressure powder-gas powder feeding port 15, and an air pressure regulating valve 8 is arranged on an outer surface of the end, close to the high-pressure air source 5, of the air pipe. Kinetic energy of cold spray particles is provided by the high-pressure gas source 5, the gas source is generally nitrogen, helium or compressed air, the pressure is 0.3-5.0 MPa, and pressure of the gas source may be regulated and controlled by the air pressure regulating valve 8. When high-pressure gas flows in the air pipe, it is heated by the high-pressure airflow heater 10 to a certain temperature, and finally enters the powder-gas mixed channel 12 and the low-pressure powder-gas powder feeding port 15. The powder-gas mixed channel 12 and the low-pressure powder-gas powder feeding port 15 could be selected according to actual processing requirements.

With reference to FIG. 1 and FIG. 2, the high-pressure airflow heater 10 is arranged on an outer surface of the portion, at a right end of the air pressure regulating valve 8, of the air pipe, an inner cavity of the powder feeder 6 is in communication with a powder pipe 4, and the end, far away from the powder feeder 6, of the powder pipe 4 is in communication with inner cavities of the powder-gas mixed channel 12 and the low-pressure powder-gas powder feeding port 15. Delivery of cold spray powder is mainly achieved by the powder feeder 6. A powder regulating valve 3 fixed on the powder pipe 4 may regulate a flow rate of the powder, and a powder feeding rate is 10-500 g/min. The powder is heated by a powder airflow heater 9, and finally delivered to interiors of the powder-gas mixed channel 12 and the low-pressure powder-gas powder feeding port 15.

With reference to FIG. 1 and FIG. 2, the laser device 1 is electrically connected to an input end of the water cooling system 7, an inner cavity of the water cooling system 7 is in communication with a water pipe, and the end, far away from the water cooling system 7, of the water pipe is in communication with the integrated spray gun 13. During the laser assisted cold spray process, the integrated spray gun 13 is also cooled, cooling and temperature control are both performed by means of the water cooling system 7, and the moving speed of the integrated spray gun is 5-200 mm/s. When the laser assisted cold spray repair is completed, laser shock peening is required, and this process is also performed on the device. During the laser shock peening process, the cold spray module is stopped, and only a laser beam module is reserved. In this case, the laser device 1 is set to emit laser with nanosecond pulse duration, the laser energy is adjustable by 10-200 μJ, the repetition frequency range is 300-2000 Hz, and the laser enters the integrated spray gun 13 by means of an optical path system. A diameter of laser spots focused on the surface of the specimen is adjustable and is 0.3-0.6 mm.

With reference to FIG. 1 and FIG. 2, the inner cavity of the low-pressure powder-gas powder feeding port 15 is in communication with the integrated spray gun 13, a processing zone of the mobile platform 16 is provided with a specimen to be processed 17, the specimen 17 is positioned right below the integrated spray gun 13, and a deionized water nozzle 14 is arranged above a right side of the specimen 17. During the laser shock peening process, a water confinement layer needs to be applied to the processing areas by means of the deionized water nozzle 14 to increase the pressure of shock wave, and the thickness of the water confinement layer is about 2 mm.

With reference to FIG. 1 and FIG. 2, the inner cavity of the powder-gas mixed channel 12 is in communication with a Laval nozzle 19, the integrated spray gun 13 includes a conical housing 21, the conical housing 21 has a conical angle of 15°-60° and a minimum diameter of a front end of 30-100 mm, and a minimum diameter of the laser beam channel 22 is 1-3 mm. The number of powder-gas mixed channels 12 may be added to the conical housing 21 according to needs, and an inner diameter range of the powder-gas mixing beam channels is 3-10 mm. An inner surface of the conical housing 21 is provided with the laser beam channel 22, an inner partition plate 18 is arranged between the inner surface of the conical housing 21 and the laser beam channel 22, and an angle between a central axis of the powder-gas mixed channel 12 and a central axis of the laser beam channel 22 is 15°-60°. A water cooling system 20 is mounted between the inner surface of the conical housing 21 and an outer surface of the inner partition plate 18. The central axis of the laser beam channel 22, the central axis of the powder-gas mixed channel 12, and a central axis of the conical housing 21 are collinear, and the water cooling system 20 could cool the spray gun during operation. Under cooperation of the above structures, the cold spray particles and deposition positions could be heated in situ by using low-power density laser, so as to induce the deposition particles to form metallurgical bonding and improve the bonding strength of the coating. After cold spray repair, high-power density laser is employed to peen the repaired zone, adjust and control the residual stress field distribution around the repaired zone and optimize the microstructure so as to improve fatigue properties. The fatigue properties of the repaired specimen are restored to an original state before damage and satisfy service requirements.

Implementation principle of an example of the laser assisted cold spray repair device and process method for aviation-grade aluminum alloy structural parts of the present application is as follows:

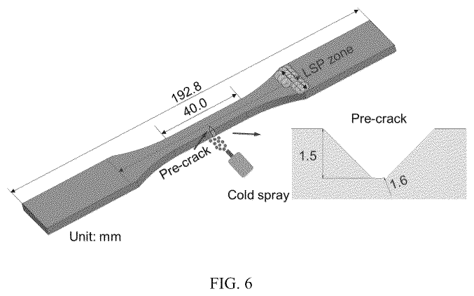

A 7075-T6 aluminum alloy specimen with pre-crack is taken as a specimen to be processed 17 for testing, as shown in FIG. 6. The specimen is repaired by employing a traditional cold spray technology, a laser assisted cold spray technology, and a laser assisted cold spray+a laser shock peening technology, respectively. The bonding strength of the repaired coating and the fatigue properties of the specimen are tested to verify the effectiveness of the device and the process provided by the present disclosure.

Firstly, the specimen 17 is place into an acetone solution for ultrasonic cleaning for 15 minutes to remove surface residue, and then the specimen 17 is fixed on the mobile platform 16, such that a pre-crack position of the specimen 17 faces upwards and is opposite the integrated spray gun 13 with a distance of 10 mm. The powder is 7075 aluminum alloy powder, which is prepared through a gas atomization method and has good fluidity, and has a diameter of 10-100 μm, and an average diameter of 21.5 μm. The powder is added into the powder feeder 6, the powder feeding rate is set to 1.5 r/min, the pressure of the high-pressure gas source 5 is adjusted to 0.8 MPa, and the heating temperature of the high-pressure airflow heater 10 is set to 450° C.

The laser device 1 is started, laser power is set to be 500 W, and the diameter of laser spot is 3 mm. The temperature of the laser irradiation zone is measured to be 300° C. by means of an infrared thermometer. When the temperature is stable, laser assisted cold spray repair is performed on the pre-crack position. When the repair is completed, the specimen 17 is taken down to remove the reinforcement of the repaired zone by abrasive paper, and the size of the specimen is restored to the original state. Then, the specimen 17 is fixed on the mobile platform 16 again, the mobile platform 16 is positioned at a laser focus position, laser shock peening is performed on the surface of the repaired zone, the laser energy is set to be 150 mJ, the laser spot diameter is 0.5 mm, an overlapping rate is set to be 50%, and the laser scanning path is in a zigzag shape. The deionized water nozzle 14 is opened, the deionized water uniformly covers the surface of the repaired zone, and then laser shock peening is performed. When the peening is completed, the specimen was taken down and placed in an acetone solution for ultrasonic cleaning for 15 minutes to complete the whole repairing process.

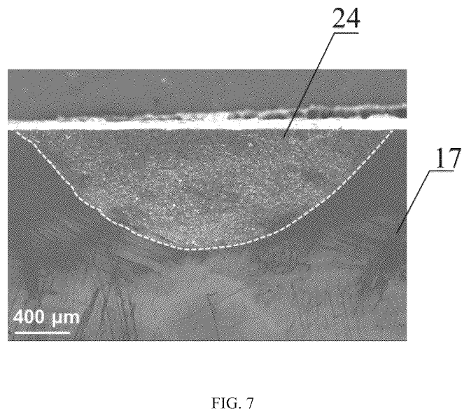

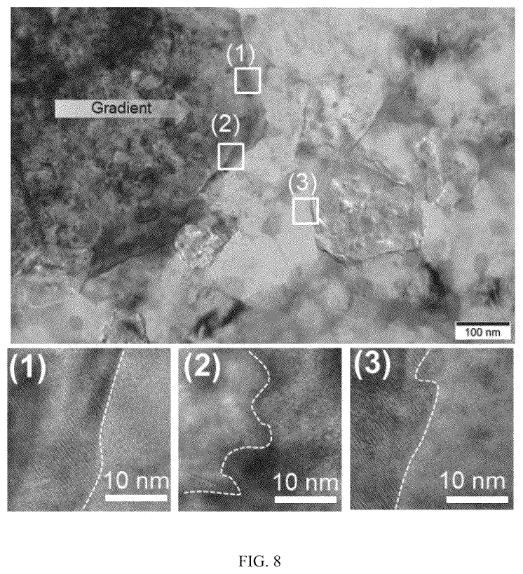

After the repairing and peening, the quality of the deposition is observed by using a scanning electron microscope, and results are shown in FIG. 7. It could be seen that the deposition 24 is compact and uniform, surface defects are small, and the coating quality is good. The microstructure of the deposition layer is observed by using a transmission electron microscope (TEM), and results are shown in FIG. 8. From the figure, it could be seen that the dislocation density is high at the grain boundary, which indicates that the deformation of the most outer surface of the particles is more intense during the deposition process, and massive dislocations accumulate here. In addition, the dislocation density shows a gradient distribution along with the increase of distance away from the grain boundary, and a high-resolution TEM image shows that the grain boundary presents a saw-tooth shape, which indicates that metallurgical bonding is formed, and proves that the method and the process provided by the present disclosure change the bonding mode of the particles, and mechanical bonding is changed into metallurgical bonding.

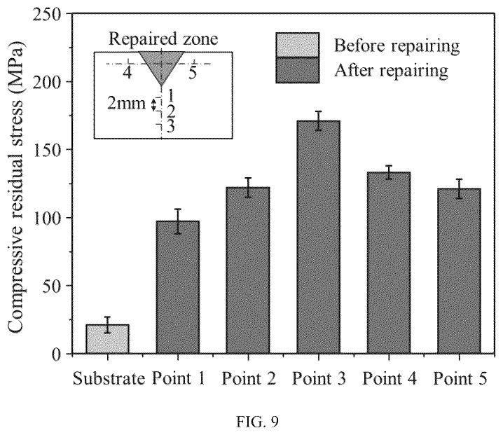

An X-ray diffraction method is used for the residual stress test around the repaired zone of the specimen after the repair and peening, and results are shown in FIG. 9. It could be seen that the compressive residual stress of a substrate before repair is about 25 MPa. After repairing, the compressive residual stress is lower than 100 MPa. And the maximum compressive residual stress of repaired zone exceeds 175 MPa, which indicates that the method provided by the present disclosure achieves regulation and control of residual stress in the repaired zone.

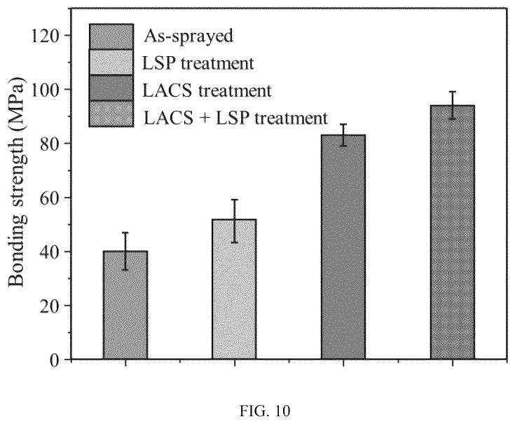

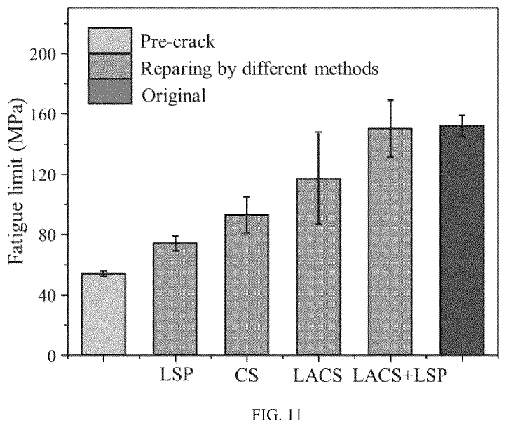

Bonding strength of the deposition is tested, and results are shown in FIG. 10, where “as-sprayed” represents cold spray, “LSP treatment” represents laser shock peening, “LACS treatment” represents laser assisted cold spray, and “LACS+LSP treatment” represents laser assisted cold spray+laser shock peening. The bonding strength of a traditional cold spray coating is only 40±7 MPa, the bonding strength of the specimen subjected to the LSP treatment and LACS treatment are improved to 5318 MPa and 83±4 MPa respectively, while the bonding strength of the coating by using the method proposed in the present disclosure is further improved and is up to 94±5 MPa, which proves the effectiveness of the method in improving the bonding strength of the coating. The fatigue strength of the specimen treated by different processes is tested using a step-by-step loading method, and results are shown in FIG. 11, where “pre-crack” represents a pre-cracked specimen, “CS” represents cold spray, “LSP” represents laser shock peening, “LACS” represents laser assisted cold spray, “LACS+LSP” represents laser assisted cold spray+laser shock peening, and “original” represents an original state. The fatigue strength of the pre-cracked specimen is 54±2 MPa, which is only 36% of that of the original specimen (152±7 MPa). When the specimen with pre-crack is subjected to the laser shock peening, the fatigue strength is increased to 74±5 MPa even though the crack still exists. After repair by using the traditional cold spray technology, the fatigue strength is increased to 93±12 MPa, which is 60% of that of the original strength. After repair by using the laser assisted cold spray, the fatigue strength is increased to 117±30 MPa, but is still lower than that of the original state. When the repair and peening technology are both used, the fatigue strength is further improved to 150±19 MPa and basically reaches that of the original state, which proves that the method provided by the present disclosure may achieve recovery of the fatigue property of the damaged part.

In the present disclosure, for the laser assisted cold spray high performance repair method and device, cold spray particles and deposition positions are heated in situ by using low-power density laser, so as to induce the deposition particles to form metallurgical bonding and improve the bonding strength of coating. After cold spray repair, high-power density laser is employed to peen the repaired zone, regulate and control the residual stress field distribution around the repaired zone and optimize microstructure so as to improve the fatigue properties. The fatigue properties of the repaired aviation-grade aluminum alloy bearing parts are restored to an original state before damage and satisfy service requirements.

1. A laser assisted cold spray repair device for aviation-grade aluminum alloy structural parts, comprising a laser device (1), a high-pressure gas source (5), a powder feeder (6), a water cooling system (7), a reflector (11), an integrated spray gun (13) and a mobile platform (16), wherein an output end of the laser device (1) emits a laser beam (2), the laser beam (2) enters an interior of the integrated spray gun (13) after being refracted by the reflector (11), an inner cavity of the high-pressure gas source (5) is in communication with an air pipe, the end, far away from the high-pressure gas source (5), of the air pipe is in communication with a powder-gas mixed channel (12) and a low-pressure powder-gas powder feeding port (15), an air pressure regulating valve (8) is arranged on an outer surface of the end, close to the high-pressure air source (5), of the air pipe, a high-pressure airflow heater (10) is arranged on an outer surface of the portion, at a right end of the air pressure regulating valve (8), of the air pipe, an inner cavity of the powder feeder (6) is in communication with a powder pipe (4), the end, far away from the powder feeder (6), of the powder pipe (4) is in communication with inner cavities of the powder-gas mixed channel (12) and the low-pressure powder-gas powder feeding port (15), an inner cavity of the water cooling system (7) is in communication with a water pipe, the end, far away from the water cooling system (7), of the water pipe is in communication with the integrated spray gun (13), the inner cavity of the low-pressure powder-gas powder feeding port (15) is in communication with the integrated spray gun (13), the inner cavity of the powder-gas mixed channel (12) is in communication with a Laval nozzle (19), a processing zone of the mobile platform (16) is provided with a specimen to be processed (17), and the specimen (17) is positioned right below the integrated spray gun (13).

2. The laser assisted cold spray repair device for aviation-grade aluminum alloy structural parts according to claim 1, wherein a deionized water nozzle (14) is arranged above a right side of the specimen (17).

3. The laser assisted cold spray repair device for aviation-grade aluminum alloy structural parts according to claim 1, wherein the laser device (1) is electrically connected to an input end of the water cooling system (7).

4. The laser assisted cold spray repair device for aviation-grade aluminum alloy structural parts according to claim 1, wherein the integrated spray gun (13) comprises a conical housing (21), a laser beam channel (22) is arranged inside the conical housing (21), and an inner partition plate (18) is arranged between the conical housing (21) and the laser beam channel (22).

5. The laser assisted cold spray repair device for aviation-grade aluminum alloy structural parts according to claim 4, wherein an angle between a central axis of the powder-gas mixed channel (12) and a central axis of the laser beam channel (22) is 15°-60°.

6. The laser assisted cold spray repair device for aviation-grade aluminum alloy structural parts according to claim 4, wherein a water cooling channel (20) is located between an inner surface of the conical housing (21) and an outer surface of the inner partition plate (18).

7. The laser assisted cold spray repair device for aviation-grade aluminum alloy structural parts according to claim 4, wherein the central axis of the laser beam channel (22), the central axis of the powder-gas mixed channel (12) and a central axis of the conical housing (21) are collinear.

8. The laser assisted cold spray repair device for aviation-grade aluminum alloy structural parts according to claim 4, wherein the conical housing (21) has a conical angle of 15°-60° and a minimum diameter of a front end of 30-100 mm, and a minimum diameter of the laser beam channel (22) is 1-3 mm.

9. A laser assisted cold spray repair process method for aviation-grade aluminum alloy structural parts, employing the device according to claim 1 and comprising:
S1, placing the specimen (17) in an acetone solution for ultrasonic cleaning for 10-30 minutes to remove residues, and fixing the specimen on the mobile platform (16);
S2, designing a laser assisted cold spray process according to size characteristics of a damage position, which comprises a powder material, gas pressure, laser source power, spray gun moving speed and path, etc.;
S3, performing laser assisted cold spray treatment, wherein the laser device (1) and the water cooling system (7) are started, a laser focused spot size and the laser power are adjusted, a temperature of a laser irradiation position is measured by using an infrared thermometer, powder is loaded, output gas pressure is adjusted, a high-pressure powder feeding powder-gas mixed channel or a low-pressure powder feeding powder-gas mixed channel is selected according to needs, a distance from the integrated spray gun (13) to a surface of the specimen (17) is adjusted, the distance from the integrated spray gun (13) to the surface of the specimen (17) is typically 5-30 mm, a distance from an intersection point of the laser beam (2) and the cold spray particles (23) to the surface of the specimen (17) is generally 0.1-10 mm, trial operation is performed on the device, when a deposition (24) is stably formed, repair process is performed, during the repair process, it is observed whether the moving path of a laser spot (24) is implemented according to a designed path, and if there is deviation, the device is stopped in time for readjustment;
S4, when the cold spray repair is completed, taking down the specimen (17), and removing the reinforcement (24) with abrasive paper, such that the size characteristics of the repaired specimen to be processed (17) are restored to an original state; observing and evaluating the quality of the deposition (24), if the deposition quality satisfies the requirements, performing S5, and if not, determining the specimen as a waste product;
S5, formulating laser shock peening process according to the characteristics of the repaired zone, which comprises parameters such as laser power density, a laser spot scanning path, processing zone, etc.;
S6, fixing the repaired specimen to be processed (17) on the mobile platform (16), starting the laser device (1), adjusting the position of the specimen (17), such that the specimen (17) is located at the laser focus, adjusting the size of the laser spot (26), inputting laser energy and the scanning path, commissioning the device, and observing the moving path of the spot; starting the deionized water nozzle (14), after a water confinement layer stably covers the peening zone, performing laser shock peening, wherein the peening zone (25) covers the whole deposition (24), observing whether the deposition (24) is damaged and the scanning path of the laser spot, and if there is a phenomenon such as coating damage or laser deviation, stopping the device in time for readjustment;
S7, when peening is completed, dismounting the specimen (17), and placing same in an acetone solution for ultrasonic cleaning for 10-30 minutes to remove surface residues, thereby completing repair and peening.
